(19) United States
(12) Patent Application Publication
(10) Pub. No.: US 2006/0101035 A1
(43) Pub. Date: May 11, 2006

(54) System and method for blog functionality

(76) Inventors: Minna M. Mustakallio, Helsinki (FI); Christian B. Lindholm, Helsinki (FI); Calin Turcanu, Helsinki (FI)

Correspondence Address: MORGAN & FINNEGAN, L.L.P., 3 World Financial Center, New York, NY, 10281-2101, US

(21) Appl. No.: 10/988,274

(22) Filed: Nov. 11, 2004

(51) Int. Cl. G06F 17/30

(52) U.S. Cl. 707/100

(57) ABSTRACT

Systems and methods applicable, for instance, in blog functionality. For example, a blog entry may be created that exists both in a media diary and as part of a blog. As another example, notifications regarding blogs may be received. As yet another example, a contacts card may convey details of one or more blogs.

### FIELD OF INVENTION

This invention relates to systems and methods for blog functionality.

### BACKGROUND INFORMATION

In recent years, there has been an increase in the use of blogs. For example, users have increasingly come to employ blogs in expressing themselves, in learning the viewpoints of others, as a source of news, and as a source of entertainment.

Accordingly, there may be interest in technologies that, for example, that facilitate the use of blogs.

### SUMMARY OF THE INVENTION

According to embodiments of the present invention, there are provided systems and methods applicable, for instance, in blog functionality.

In various embodiments, a blog entry may be created that exists both in a media diary and as part of a blog. Moreover, in various embodiments notifications regarding blogs may be received. Additionally, in various embodiments a contacts card may convey details of one or more blogs.

### BRIEF DESCRIPTION OF THE DRAWINGS

FIG. 1 shows an exemplary graphical user interface (GUI) display according to various embodiments of the present invention.

FIG. 2. shows a further exemplary graphical user interface (GUI) display according to various embodiments of the present invention.

FIG. 3 shows exemplary steps involved in blog entry functionality according to various embodiments of the present invention.

FIG. 4 shows further exemplary steps involved notification functionality according to various embodiments of the present invention.

FIG. 5 shows an exemplary computer.

FIG. 6 shows a further exemplary computer.

### DETAILED DESCRIPTION OF THE INVENTION

General Operation

According to embodiments of the present invention there are provided systems and methods applicable, for instance, in blog functionality.

For example, in various embodiments a user may be able to create a blog entry that exists both as a media item in a media diary and as part of a blog. There may, in various embodiments, be coordination between the blog entry as it exists in the media diary and the blog entry as it exists as part of the blog. Moreover, in various embodiments the blog entry may include media items selected from the media diary.

As another example, in various embodiments a wireless node and/or other computer of a user may be able to receive notifications regarding blogs. As yet another example, in various embodiments a contacts card corresponding to a user may contain one or more fields conveying details of one or more blogs.

Various aspects of the present invention will now be discussed in greater detail.

Blog Entry Functionality

According to various embodiments of the present invention, a user may indicate to her wireless node and/or other computer a desire to create a new blog entry. The user might, for instance, provide such indication via a graphical user interface (GUI) and/or other interface provided by the wireless node and/or other computer.

Responsive to the indication, the wireless node and/or other computer might, for instance, provide the user access to an editor to employ in specifying the content of the new blog entry. It is noted that, in various embodiments, the user may be able to employ the editor to change an existing blog entry (e.g., an existing blog entry selected from a media diary (discussed in greater detail below) via a provided GUI and/or other interface).

Such an editor might be provided in a number of ways. For instance, the editor might be provided using software located on the wireless node and/or other computer. Such software might, in various embodiments, be provided to the wireless node and/or other computer by a remote device (e.g., a blog server or service provider). Alternately or additionally, the editor might be provided using software located at a remote device (e.g., a blog server or service provider), with the editor perhaps being provided as a web application, an applet, and/or a web service. Accordingly, in various embodiments, a wireless node and/or other computer might provide to its user, perhaps via a provided media diary, a link to an editor located at a remote device (e.g., a server on the Internet).

A media diary may, in various embodiments, be provided for a user by her wireless node and/or other computer. Such a media diary might, for instance, provide (e.g., via a GUI and/or other interface) a timeline displaying and/or providing access to various media items collected at the wireless node and/or other computer. Such collected media items might include, for example, images, sounds, audio, video, and/or movies captured and/or received by the wireless node and/or other computer, and/or messages (e.g., emails, Multimedia Messaging Service (MMS) messages, and/or Short Message Service (SMS) messages) created at and/or received by wireless node and/or other computer.

The timeline might, for example, so display and/or provide access to various media items via the timeline (e.g., by periods of times) such that chronological order of the media items (e.g., as indicated by timestamps and/or other chronological information associated with the media items) is taken into account. Such time stamps and/or other chronological information might, in various embodiments, be implemented via metadata.

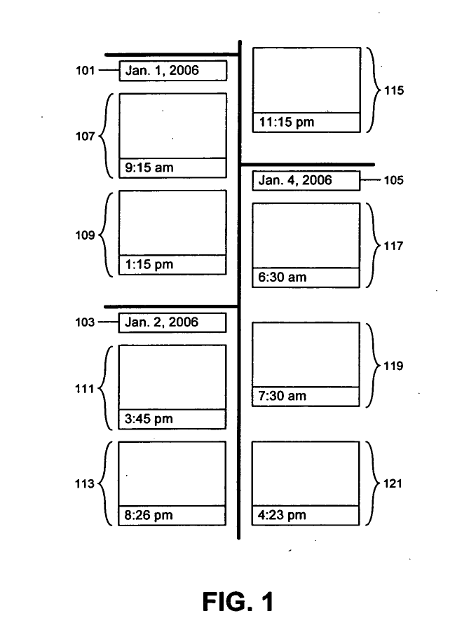

Shown in FIG. 1 is an exemplary media diary GUI display according to various embodiments of the present invention. Presented by the exemplary media diary display are date indicators 101-105 and media items indicators 107-121. The media item indicators might, in various embodiments, be presentations of media items themselves (e.g., the media diary display might display images and/or messages), and/or the media item indicators might provide access to media items (e.g., user selection of a media item indicator might result in presentation of the corresponding media item). In the exemplary media diary display of FIG. 1, media items indicators are placed in order, and associated with date indicators, in accordance with chronological information of their corresponding media items.

For example, media item indicator 107 corresponds to a media item dated Jan. 1, 2006 at 9:15 a.m., and media item indicator 109 corresponds to a media item dated Jan. 1, 2006 at 1:15 p.m. Media item indicators 107 and 109 are, in FIG. 1, placed in chronological order and graphically associated with the date indicator for Jan. 1, 2006 (101). As another example, media item indicators 111-115 are, in FIG. 1, placed in chronological order and graphically associated with appropriate date indicator 103. Date indicator 103 and its associated media item indicators are placed in chronological order with respect to date indicator 101 and its associated media item indicators 107 and 109. Moreover, date indicator 103 and its associated media item indicators are placed in chronological order and with respect to date indicator 105 and its associated media item indicators 117-121.

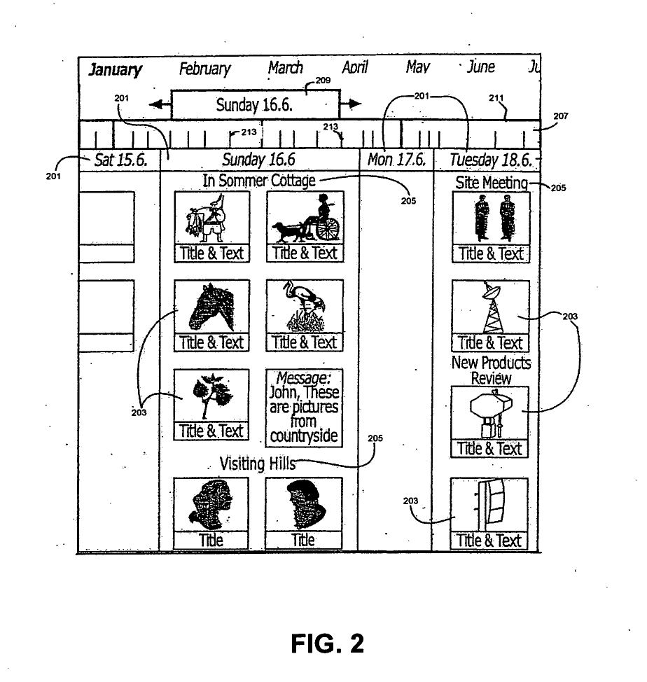

Shown in FIG. 2 is a further exemplary media diary GUI display according to various embodiments of the present invention. Presented, for example, are time pillars 201. In this exemplary display, time pillars 201 correspond to specific dates. It is noted that, in various embodiments, a time pillar might instead correspond to a unit of time other than a date (e.g., a time pillar might correspond to a year, month, week, or hour). Time pillars 201 of FIG. 2 include media item indicators 203. For instance, included with the time pillar for “Sunday 16.6”, are media item indicators for media items having chronological information appropriately specifying “Sunday 16.6”.

The width of a time pillar may, in various embodiments, dynamically and/or automatically vary based upon the number of media item indictors in the pillar, the size of media item indictors in the pillar, and/or user preference. Although in this exemplary display time pillars 201 are presented vertically, in various embodiments time pillars might be presented horizontally.

Further in this exemplary display, joint groups 205 are provided whereby media item indicators are grouped together in view of various commonalities among corresponding media items. For example, grouping might be with respect to locations, events, time periods, and/or metadata. In the exemplary media diary display of FIG. 2, for instance, various media item indicators are grouped as “Visiting Hills”.

In various embodiments, one or more viewing options may be provided to a user. For example, a user might be able to request a condensed view wherein only dates having associated media item indicators are displayed, and/or be able to request that only media item indictors corresponding to specified types of media items be displayed. Moreover, in various embodiments, a user might be able search for media items. Additionally, in various embodiments a user might be able zoom in or out whereby, for instance, zooming out might provide display of more time pillars, but corresponding media item indicators might, perhaps, be displayed with less detail (e.g., visual detail).

Presented by the exemplary media diary display of FIG. 2 are time bar 207 and time handle 209. A time handle, in various embodiments, allows for scrolling of display forward and backwards in time. A time handle might, for example, be associated with the centermost displayed time pillar. For example, in FIG. 2 time handle 209 is associated with “Sunday 16.6”.

In the exemplary media diary display of FIG. 2, bold cased blocks 211 on time bar 207 indicate time units (e.g., weeks). Further in the exemplary media diary display of FIG. 2, individual vertical lines 213 indicate ranges for dates having corresponding media items. Accordingly, in various embodiments, spaces between such vertical lines indicate the numbers of media items associated with particular dates.

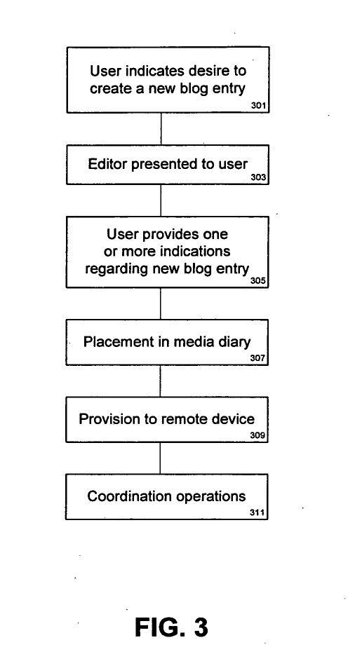

With respect to FIG. 3 it is noted that, according to various embodiments, a user might indicate her desire to create a new blog entry (step 301), and/or an editor might be presented to the user (step 303), via a media diary provided by her wireless node and/or other computer. In various embodiments, prior to steps 301 and/or 303 the user might select one or more media items from the media diary (e.g., via timeline presentation). Accordingly, for instance, the user might be able to indicate her desire to create the new blog entry via a GUI and/or other interface of the media diary, and/or the editor might be provided to the user via a GUI and/or other interface of the media diary. Alternately or additionally, the editor might be presented to the user separately from a provided media diary. For instance, a separate GUI and/or other interface might be provided.

Via the editor, various functionality for specifying the content of the new blog entry may, in various embodiments, be provided. For example, via a GUI and/or other interface associated with the editor the user might be able to indicate, select, edit, and/or add a title for the new blog entry, indicate, select, edit, and/or add one or more names of one or more blogs to which the blog entry is to be posted, indicate, select, edit, and/or add one or more Universal Resource Locators (URLs) and/or network addresses for one or more blogs to which the blog entry is to be posted, indicate, select, edit, and/or add one or more media items, perhaps selected from the media diary, to be included in the blog entry, indicate, select, edit, and/or add metadata to be associated with the blog entry, and/or indicate, select, edit, and/or add text and/or other description to be included in the blog entry (step 305). Such indication of text and/or other description might, for instance, involve use of a keyboard, a keypad, handwriting recognition, and/or voice recognition.

It is noted that, in various embodiments, a user might be able to specify that one or more media items be posted to a blog (e.g., as one or more blog entries) by placing those items in a blog folder provided, for instance, by her wireless node and/or other computer. Accordingly, for example, the user might employ a GUI provided by her wireless node and/or other computer to select one or more media items that she desired to be posted to a blog and indicate that they be moved and/or copied to the blog folder.

With a user having acted to specify the content of a new blog entry (e.g., by using a provided editor and/or by placing one or more items in a blog folder), one or more operations may, in various embodiments, be performed to create the new blog entry such that it exists as a media item in the media diary and/or as part of an appropriate blog. Such functionality may be implemented in a number of ways.

For instance, a media item corresponding to the specified blog entry might be placed, perhaps in a chronologically appropriate location (e.g., in accordance with date of creation), in the user's media diary (step 307). Placement might, in various embodiments, be in accordance with timeline presentation. Alternately or additionally, in various embodiments, the media item corresponding to the specified blog entry might be placed in accordance with metadata information included in and/or associated with the blog entry. Accordingly, for instance, the media item might convey the content specified by the user for the blog entry, and/or the media item might be presented in a media diary GUI display (e.g., in a manner analogous to that discussed above). It is noted that the media item might, for example, include data corresponding to various specified content, and/or might possess links to various specified content.

Alternately or additionally, data corresponding to content of the specified blog entry, a layout, and/or links to such content, might be provided to a remote device (e.g., a blog server) for placement in an appropriate blog, the appropriate blog perhaps being specified by URL and/or network address (step 309). Implementation of such functionality might, in various embodiments, involve communication between the wireless node and/or other computer and the remote device (e.g., a server) employing protocols such as Remote Method Invocation (RMI), Java Messaging Service (JMS), Simple Object Access Protocol (SOAP), Atom, Really Simple Syndication (RSS), email, Multimedia Messaging Service (MMS), and/or Short Message Service (SMS). The appropriate blog and/or an URL and/or network address of the appropriate remote device might, for instance, be indicated by the user in specifying the content of the blog entry, be retrieved from accessible storage, and/or be specified during one or more setup operations (e.g., initial setup operations). Upon receipt the remote device could, for instance, modify an appropriate blog to include the new entry.

It is noted that in various embodiments, one or more conversion operations may be performed in order to prepare a blog entry specified by a user for placement in an appropriate blog. Such conversion operations might, for instance, be performed by the user's wireless node and/or other computer, and/or by a remote device (e.g., a blog sever). Alternately or additionally, in various embodiments one or more templates might be employed.

Such templates might, for instance, be provided to a user's wireless node and/or other computer by a remote device (e.g., a blog server), by a manufacturer of the wireless node and/or other computer, by a service provider, and/or the like. According to various embodiments of the present invention, a user specifying content of a new blog entry might be able to select one or more available templates to employ in conjunction with the new blog entry. Such selection might, for instance, be performable via an editor of the sort discussed above, and/or via a provided GUI and/or other interface. It further is noted that, in various embodiments, a blog entry as it exists in a media diary and as it exists as part of an appropriate blog might be in the same form (e.g., possess identical layout) or be in differing forms.

In the case where a blog entry is made to exist as both a media item in a media diary and as part of an appropriate blog, one or more operations may, in various embodiments, be performed. For instance, one or more operations may be performed to achieve coordination between the blog entry as it exists in the media diary and the blog entry as it exists as part of the blog (step 311).

Accordingly, for example, in various embodiments, in the case where a blog entry as it exists in a media diary is changed (e.g., by a user via an editor, perhaps of the sort discussed above, and/or via an automated process such as software running on the user's wireless node and/or other computer), the content of the blog entry as it exists as part of a blog may be altered to include the change. As another example, in various embodiments in the case where a blog entry as it exists as part of a blog is changed (e.g., in the case where one or more replies are posted to the blog), the content of the blog entry as it exists in a media diary may be altered to include the change (e.g., some or all of the replies).

Such functionality may be implemented in a number of ways. For instance, implementation could involve communication between an appropriate wireless node and/or other computer (e.g., one holding some or all of the media diary) and an appropriate remote device (e.g., a blog server hosting the blog) employing RMI, JMS, SOAP, Atom, RSS, email, MMS, and/or SMS. It is noted that, in various embodiments, such use of Atom and/or RSS might involve the use of private and/or secure (e.g., encrypted) feeds between the wireless node and/or other computer and the remote device.

It is noted that, in various embodiments, a blog entry as it exists in a media diary may be altered to include usage information regarding the blog entry as it exists as part of a blog. Such usage information might, for instance, include number of accesses to the blog entry as it exists as part of the blog, times of accesses of blog entry as it exists as part of the blog, and/or names and/or other identifications of users accessing the blog entry as it exists as part of the blog. Implementation of such functionality might, in various embodiments, involve communication between an appropriate wireless node and/or other computer (e.g., one holding some or all of the media diary) and an appropriate remote device (e.g., a blog server hosting the blog) employing RMI, JMS, SOAP, Atom, RSS, email, MMS, and/or SMS.

According to various embodiments of the present invention, various metadata operations may be performed. For example, metadata might be associated with a blog entry. Such metadata might, for instance, include some or all of metadata corresponding to media items selected for the blog entry. Alternately or additionally, such metadata might include date of creation, name of created blog entry, URL and/or network address of corresponding blog, and/or blog service provider information. It is noted that, in various embodiments, a user might be able to, perhaps via an editor (e.g., one of the sort discussed above), specify metadata for association with a blog entry and/or be able to edit and/or add blog entry metadata. Alternately or additionally, various metadata might, in various embodiments, be automatically associated with a blog entry.

As another example, in the case where media items are selected for a blog entry, metadata associated with the blog entry (e.g., metadata specifying name of blog entry, and/or metadata specifying one or more dates of selection of the media items) might be associated with the media items.

One or more media items (e.g., media items from a media diary of a user) might, in various embodiments, be suggested, (e.g., by action of a wireless node and/or other computer of the user), for inclusion in a new and/or existing blog entry. Such functionality may be implemented in a number of ways. Such suggestion might, in various embodiments, be automatic.

For example, in various embodiments, metadata may be associated with a user's blog (e.g., via action of the user, perhaps via a provided GUI and/or other interface), and operations might be performed (e.g., by the user's wireless node and/or other computer) to compare that blog metadata with metadata associated with media items (e.g., those from a media diary of the user). Such comparison might, for instance, be performed periodically, with capture, receipt, and/or creation of one or more new media items, and/or upon an initial run of corresponding software. In the case where one or more matches were found, the one or more corresponding media items might, in various embodiments, be suggested for inclusion in a new and/or existing blog entry.

Accordingly, for instance, the user might receive such suggestion via a GUI and/or other interface provided by her wireless node and/or other computer. In response the user might, for instance, agree that one or more of suggested media items be included in a blog entry, the user perhaps being able to specify whether a new blog entry be created or an existing blog entry be edited. Alternately or additionally, the user might be able to accept or decline a suggestion that a new blog entry be created and/or that an existing blog entry be employed for inclusion of one or more of the suggested media items. The user might, in various embodiments, be able to make use of some or all of functionality discussed above (e.g., editor functionality) with respect to a blog entry to be employed for one or more of suggested media items.

It is noted that, in various embodiments, stored as one or more media items in a media diary of a user may be some or all of another user's blog. For example, one or more blog entries of the other user's blog might be stored as one or more media items. Such a blog entry media item might, for instance, provide access to the blog corresponding to the blog entry. Accordingly, for instance, one or more appropriate URLs and/or network addresses might be included with a blog entry media item and a user might, perhaps via interface and/or web browser functionality provided by her wireless node and/or other computer, be able to select an included URL and/or network address and follow it the corresponding blog.

It is further noted that, in various embodiments, one or more blog entries of another user's blog and/or a blog of the user might be stored in one or more blog folders. Such a blog folder might, for instance, possess a name in accordance with a name of the other user's blog, the other user's name, and/or associated metadata.

Notification Functionality

A wireless node and/or other computer of a user may, according to various embodiments of the present invention, be able to receive notifications regarding blogs. Such a notification might, for instance, regard a blog of the user or a blog of another user. A wireless node and/or other computer receiving such a notification, might, in various embodiments, inform its user (e.g., via a GUI and/or other interface).

Accordingly, for example, a wireless node and/or other computer of a user might be notified of the addition of a new blog entry to a blog of another user, the existence of unread blog entry at that blog, the addition of a blog entry reply at that blog, the editing of a blog entry, and/or the presence of an unread blog entry reply at that blog. As another example, a wireless node and/or other computer might be notified of usage information (e.g., the addition of a blog entry reply, the presence of an unread blog entry reply, and/or various values) regarding a blog of its user.

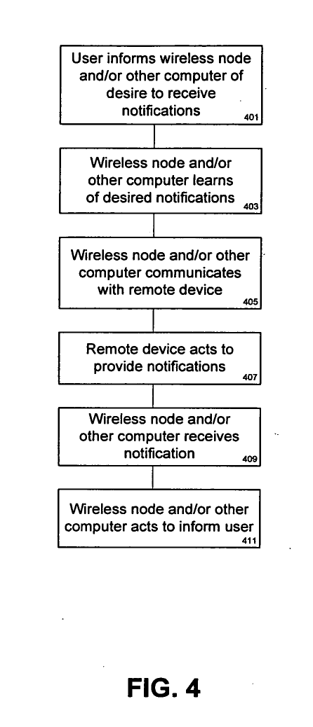

Such functionality may be implemented in a number of ways. For example with respect to FIG. 4 it is noted that, in various embodiments, in the case where a user of a wireless node and/or other computer desired to receive blog notifications, the user could inform her wireless node and/or other computer of such (e.g., via a GUI and/or other interface provided by her wireless node and/or other computer) (step 401).

The wireless node and/or other computer might, for example, act to learn from its user the notifications she wished it to receive (step 403). Accordingly, for example, the wireless node and/or other computer might (e.g., via a GUI and/or other interface) inform the user of the available notifications, and query her as to the ones she wished to be received.

Accordingly, for example, the user might be able to indicate that she wished her wireless node and/or other computer to receive notifications regarding addition of new blog entries to one or more specified blogs of other users, the existence of unread blog entries at one or more specified blogs of others users, the addition of replies to one or more specified blogs of other users, and/or the existence of unread replies to one or more specified blogs of other users.

As another example, the user might be able to indicate that she wished her wireless node and/or other computer to receive notifications regarding usage of one or more of her blogs. For instance, the user might be able to indicate that her wireless node and/or other computer should receive notifications regarding addition of replies to one or more of her blogs, existence of replies that she had not yet read at one or more of her blogs, number of accesses to one or more of her blogs (e.g., within one or more specified time intervals), names of users accessing one or more of her blogs, and/or times of accesses to one or more of her blogs (e.g., within one or more specified time intervals).

It is noted that, in various embodiments, some or all of such received notifications and/or data conveyed thereby might be placed in the user's media diary and/or be appended to an appropriate blog entry as it exists in one or more of her media diaries. Accordingly, for example, a blog entry as existing in a media diary of the user might be updated to include responses to her entry supplied by other users. Alternately or additionally, in various embodiments, some or all of such received notifications and/or data conveyed thereby might be stored in one or more blog folders.

Having receiving such indication automatically and/or from its user, the wireless node and/or other computer could, in various embodiments, communicate with a remote device (e.g., a presence server) (step 405). Such communication might, in various embodiments, employ RMI, JMS, SOAP, Atom, RSS, email, MMS, and/or SMS. It is noted that, in various embodiments, such use of Atom and/or RSS might involve the use of private and/or secure (e.g., encrypted) feeds between the wireless node and/or other computer and the remote device. Via such communication the wireless node and/or other computer might, for instance, act in compliance with the user's indications to inform the remote device of notifications that it should provide. It is noted that, in various embodiments, provided to the remote device by the wireless node and/or other computer may be one or more URLs and/or network addresses of blogs to be monitored, and/or one or more URLs and/or network addresses of wireless nodes and/or other computers to receive notifications.

Functionality by which the remote device could act to provide to the wireless node and/or other computer desired notifications (step 407) could be implemented in a number of ways. For example, the remote device might act to examine appropriate RSS and/or Atom feeds to look for new blog entries and/or addition of replies to specified blogs. As another example, the remote device might act to, perhaps periodically, examine one or more specified blogs (e.g., by accessing blog servers and/or other devices providing them). As yet another example, in various embodiments a blog server and/or other device providing a specified blog, and/or a service provider associated with a specified blog, might act to appropriately monitor the specified blog (e.g., to look for addition of new entries and/or replies), and might provide information to the remote device as appropriate (e.g., with the addition of a new entry and/or reply).

In, for example, the case where the remote device determined, perhaps via received information, that the wireless node and/or other computer should receive notification (e.g., because an appropriate event had occurred), the remote device could act to dispatch notification to the wireless node and/or other computer. As another example, the remote device might periodically act to dispatch notification. Such periodicity might, for instance, be set by a user, a system administrator, a service provider, and/or a manufacturer.

In various embodiments, provision of such notification could involve employment of communications in a manner analogous to that discussed above. It is noted that, in various embodiments, notification might be provided as presence information, perhaps with presence information such as communication availability also being included. Such communication availability information might, for instance, indicate, perhaps with regard to various communication modalities (e.g., voice, email, SMS, and/or MMS), whether or not a user (e.g., a user that is author of a blog under consideration) is available to communicate.

After receiving notification from the remote device (step 409), one or more operations might, in various embodiments, be performed by the wireless node and/or other computer. For example, the wireless node and/or other computer might act to inform its user of a received notification, and/or of some or all of information included therewith, via a GUI and/or other interface (e.g., audio) (step 411).

In various embodiments, the wireless node and/or other computer could act to inform its user via GUI display for a contacts card corresponding to a user that was author of a blog for which notification was received. Accordingly, for example, in the case where a received notification indicated that a new entry had been posted in a blog of “Robert Jones”, the wireless node and/or other computer might act appropriately inform its user by appending text and/or graphics to display of a contacts card for Robert Jones.

As another example, the wireless node and/or other computer might act to inform its user of a received notification, and/or of some or all of information included therewith, via display (e.g., on-screen display) during a time that the wireless node and/or other computer, and/or a GUI and/or other interface thereof, was in an inactive state.

It is noted that, in various embodiments, notification received by a wireless node and/or other computer might be stored in a corresponding media diary, timeline, and/or in one or more blog folders. It is further noted that, in various embodiments, received notification might, for instance, include some or all of a new and/or unread blog entry and/or reply, include various information about a new and/or unread blog entry and/or reply, and/or might provide access (e.g., a link) to a corresponding blog and/or to a new and/or unread blog entry and/or reply.

Moreover, it is noted that, in various embodiments, a user's wireless node and/or other computer might not rely upon a remote device for notifications, but instead might act to fulfill its user's desire for notifications by, for instance, performing one or more of the operations discussed above as being performed by a remote device (e.g., examination of RSS and/or Atom feeds, and/or monitoring of specified blogs via accessing a blog server and/or other remote device).

It is noted that, in various embodiments, a wireless node and/or other computer of a user might, perhaps in a manner analogous to that discussed above, be able to receive notifications regarding usage of one or more blogs which were not her own including, for example, numbers of accesses, names of accessing users, and/or times of accesses.

Additional Functionality

A contacts card corresponding to a user may, in various embodiments, contain one or more fields conveying details of one or more blogs authored by that user. Such details might, for example, include blog URL and/or network address.

In various embodiments, a GUI and/or other interface provided by a user's wireless node and/or other computer might allow the user to access the blog corresponding to a blog URL and/or network address conveyed by such a contacts card by, for instance, presenting the blog to the user in response to the user, for example, selecting (e.g., via a provided GUI and/or other interface) the contacts cards, the URL and/or network address, and/or a “go to blog” option.

Functionality could, for example, be provided such that a user could act to employ a GUI and/or other interface provided by her wireless node and/or other computer to add to an existing contacts card corresponding to another user one or more fields conveying details of a blog authored by that other user. As another example, functionality could be provided whereby a wireless node and/or other computer could receive a contacts card including one or more fields conveying details of a blog. Such receipt might, for example, involve use of Infrared Data Association (IrDA), Bluetooth, WLAN (e.g., 802.11g), a wireless telecom network (e.g., Universal Mobile Telecommunications Service (UMTS)), SMS, MMS, email, RMI, JMS, and/or SOAP.

It is noted that, in various embodiments, a received contacts cards including one or more fields conveying details of a blog might be stored in conjunction with a media diary and/or in one or more blog folders. It is further noted that, in various embodiments, information (e.g., a URL and/or network address) regarding a blog viewed by a user (e.g., via web browser), and/or one or more portions of the blog may be stored in conjunction with a media diary and/or in one or more blog folders of the user. Moreover, in various embodiments a user's wireless node and/or other computer might allow the user to access such a blog. Such functionality might, for example, be implemented in a manner analogous to that discussed above.

In various embodiments, one or more operations might be performed so that notifications are received with regard to one or more referenced blogs (e.g., referenced by contacts cards), with regard to one or more blogs visited by a user, and/or with regard to one or more blogs having one or more portions stored in a media diary and/or in one or more blog folders. In various embodiments, a user might be able to (e.g., via a provided GUI and/or other interface) be able to specify for which of such blogs notifications should be received. Accordingly, for example, blog notification functionality could be such that a wireless node and/or other computer would receive notifications regarding one or more blogs having details conveyed by contacts cards of the wireless node and/or other computer.

Contacts cards conveying details of one or more blogs could, in various embodiments, be stored in a number of ways. For example, such cards might be stored for access by contacts software running on a user's wireless node and/or other computer, and/or be stored in conjunction with a media diary and/or in one or more blog folders. As an alternative to and/or in addition to employing contact fields to convey blog details, such details might be stored in conjunction with a buddy list accessible by a user's wireless node and/or other computer.

Blog notification functionality could, for example, be such that a GUI and/or other interface providing access to contacts of a wireless node and/or other computer could act to convey received notification (e.g., provided as presence information) corresponding to a blog authored by a user whose contacts card conveyed details of one or more of her blogs. Accordingly, for instance, text and/or graphics might be displayed in conjunction with display of a contacts card corresponding to a user in the case where notification regarding a blog of that user was received. Such text and/or graphics might, for instance, indicate that notification had been received, provide details of such notification, and/or provide various presence information.

It is noted that, in various embodiments, functionality analogous to that described with respect to contacts could be implemented with respect to a buddy list.

It is also noted that, in various embodiments of the present invention, implementation of various functionality (e.g., blog entry creation, blog access, and/or blog monitoring) may, for example, involve the use of RSS and/or Atom.

It is further noted that, in various embodiments, one or more authentication and/or encryption operations might be employed in various communications between remote device and user wireless node and/or other computer discussed herein.

It is additionally noted that, according to various embodiments, a user may, perhaps via use of her wireless node and/or other computer, perform one or more operations to set up an account with a blog service provider. Via such operations, for instance, the user's wireless node and/or other computer might come to possess, perhaps via dispatch from a remote device (e.g., a blog sever), a URL and/or network address for her blog, a URL and/or network address of a remote device (e.g., a blog server), authentication information, encryption information, editor software, and/or one or more templates. In response, the wireless node and/or other computer might, in various embodiments, perform one or more operations (e.g., it might act to install and/or associate with a media diary received editor software).

Moreover, in various embodiments of the present invention, a media diary of a user might exist at two or more wireless nodes and/or other computers of the user. For example, the media diary might exist at both a wireless node of the user and a desktop personal computer of the user.

In various embodiments, one or more operations might be performed to achieve coordination and/or synchronization for the media diary as existing at the two or more two or more wireless nodes and/or other computers. Coordination functionality might, for instance, be performed in a manner analogous to that discussed above. In various embodiments, one or more conversion operations might be performed, and/or one or more templates might be employed.

Partial coordination might, in various embodiments, be implemented. Accordingly, for example, functionality might be such that a user's media diary existed in its entirety at certain of the user's wireless nodes and/or other computers, with the media diary existing in subset form at others of the user's wireless nodes and/or other computers. Accordingly, for instance, a user's media diary might exist in its entirety at a desktop personal computer of the user, but only in subset form at a wireless node of the user.

Moreover, in various embodiments, a user might be able to provide specification (e.g., via a provided GUI and/or other interface) regarding the composure of such subset forms. Accordingly, for example, the user might be able to select particular media items to be included in a subset form of a media diary, and/or be able to specify criteria (e.g., data size values and/or ranges of values, and/or date values and/or ranges of values) dictating media items to be included in the subset form.

Hardware and Software

Various operations and/or the like described herein may be executed by and/or with the help of computers. Further, for example, devices described herein may be and/or may incorporate computers. The phrases “computer”, “general purpose computer”, and the like, as used herein, refer but are not limited to a smart card, a media device, a personal computer, an engineering workstation, a PC, a Macintosh, a PDA, a portable computer, a computerized watch, a wired or wireless terminal, phone, mobile communication device, node, and/or the like, a server, a network access point, a network multicast point, a set-top box, a personal video recorder (PVR), a game console, a portable game device, a portable audio device, a portable media device, a portable video device, a television, a digital camera, a digital camcorder, a Global Positioning System (GPS) receiver, a wireless personal sever, or the like, or any combination thereof, perhaps running an operating system such as OS X, Linux, Darwin, Windows CE, Windows XP, Windows Server 2003, Palm OS, Symbian OS, or the like, perhaps employing the Series 40 Platform, Series 60 Platform, Series 80 Platform, and/or Series 90 Platform, and perhaps having support for Java and/or Net.

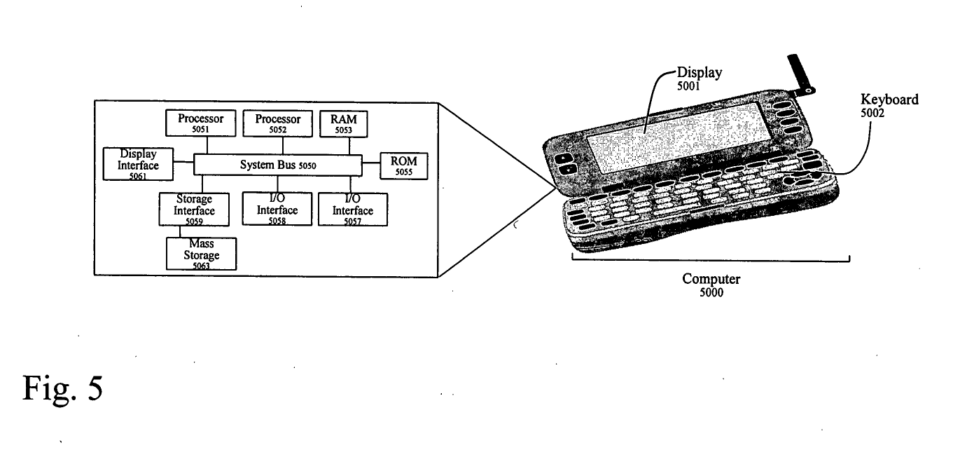

The phrases “general purpose computer”, “computer”, and the like also refer, but are not limited to, one or more processors operatively connected to one or more memory or storage units, wherein the memory or storage may contain data, algorithms, and/or program code, and the processor or processors may execute the program code and/or manipulate the program code, data, and/or algorithms. Shown in FIG. 5 is an exemplary computer employable in various embodiments of the present invention. Exemplary computer 5000 includes system bus 5050 which operatively connects two processors 5051 and 5052, random access memory 5053, read-only memory 5055, input output (I/O) interfaces 5057 and 5058, storage interface 5059, and display interface 5061. Storage interface 5059 in turn connects to mass storage 5063. Each of I/O interfaces 5057 and 5058 may, for example, be an Ethernet, IEEE 1394, IEEE 1394b, IEEE 802.11a, IEEE 802.11b, IEEE 802.11g, IEEE 802.11, IEEE 802.11e, IEEE 802.11n, IEEE 802.15a, IEEE 802.16a, IEEE 802.16d, IEEE 802.16e, IEEE 802.16×, IEEE 802.20, IEEE 802.15.3, ZigBee, Bluetooth, Wireless Universal Serial Bus (WUSB), wireless Firewire, terrestrial digital video broadcast (DVB-T), satellite digital video broadcast (DVB-S), Advanced Television Systems Committee (ATSC), Integrated Services Digital Broadcasting (ISDB), Digital Audio Broadcast (DAB), General Packet Radio Service (GPRS), Universal Mobile Telecommunications Service (UMTS), Global System for Mobile Communications (GSM), DVB-H (Digital Video Broadcasting: Handhelds), IrDA (Infrared Data Association), and/or other interface.

Mass storage 5063 may be a hard drive, optical drive, a memory chip, or the like. Processors 5051 and 5052 may each be a commonly known processor such as an IBM or Motorola PowerPC, an AMD Athlon, an AMD Opteron, an Intel ARM, an Intel XScale, a Transmeta Crusoe, a Transmeta Efficeon, an Intel Xenon, an Intel Itanium, or an Intel Pentium. Computer 5000 as shown in this example also includes a touch screen 5001 and a keyboard 5002. In various embodiments, a mouse, keypad, and/or interface might alternately or additionally be employed. Computer 5000 may additionally include or be attached to card readers, DVD drives, floppy disk drives, hard drives, memory cards, ROM, and/or the like whereby media containing program code (e.g., for performing various operations and/or the like described herein) may be inserted for the purpose of loading the code onto the computer.

In accordance with various embodiments of the present invention, a computer may run one or more software modules designed to perform one or more of the above-described operations. Such modules might, for example, be programmed using languages such as Java, Objective C, C, C#, C++, Perl, Python, and/or Xen according to methods known in the art. Corresponding program code might be placed on media such as, for example, DVD, CD-ROM, memory card, and/or floppy disk. It is noted that any described division of operations among particular software modules is for purposes of illustration, and that alternate divisions of operation may be employed. Accordingly, any operations discussed as being performed by one software module might instead be performed by a plurality of software modules. Similarly, any operations discussed as being performed by a plurality of modules might instead be performed by a single module. It is noted that operations disclosed as being performed by a particular computer might instead be performed by a plurality of computers. It is further noted that, in various embodiments, peer-to-peer and/or grid computing techniques may be employed.

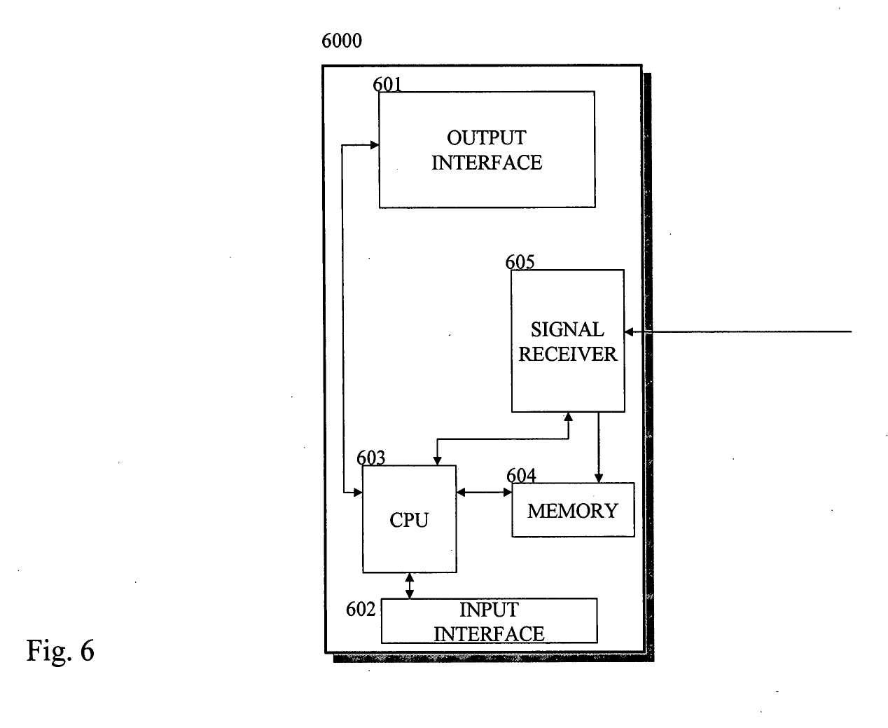

Shown in FIG. 6 is a block diagram of a terminal, an exemplary computer employable in various embodiments of the present invention. In the following, corresponding reference signs are applied to corresponding parts. Exemplary terminal 6000 of FIG. 6 comprises a processing unit CPU 603, a signal receiver 605, and a user interface (601, 602). Signal receiver 605 may, for example, be a single-carrier or multi-carrier receiver. Signal receiver 605 and the user interface (601, 602) are coupled with the processing unit CPU 603. One or more direct memory access (DMA) channels may exist between multi-carrier signal terminal part 605 and memory 604. The user interface (601, 602) comprises a display and a keyboard to enable a user to use the terminal 6000. In addition, the user interface (601, 602) comprises a microphone and a speaker for receiving and producing audio signals. The user interface (601, 602) may also comprise voice recognition (not shown).

The processing unit CPU 603 comprises a microprocessor (not shown), memory 604 and possibly software. The software can be stored in the memory 604. The microprocessor controls, on the basis of the software, the operation of the terminal 6000, such as receiving of a data stream, tolerance of the impulse burst noise in data reception, displaying output in the user interface and the reading of inputs received from the user interface. The hardware contains circuitry for detecting signal, circuitry for demodulation, circuitry for detecting impulse, circuitry for blanking those samples of the symbol where significant amount of impulse noise is present, circuitry for calculating estimates, and circuitry for performing the corrections of the corrupted data.

Still referring to FIG. 6, alternatively, middleware or software implementation can be applied. The terminal 6000 can, for instance, be a hand-held device which a user can comfortably carry. The terminal 6000 can, for example, be a cellular mobile phone which comprises the multi-carrier signal terminal part 605 for receiving multicast transmission streams. Therefore, the terminal 6000 may possibly interact with the service providers.

### RAMIFICATIONS AND SCOPE

Although the description above contains many specifics, these are merely provided to illustrate the invention and should not be construed as limitations of the invention's scope. Thus it will be apparent to those skilled in the art that various modifications and variations can be made in the system and processes of the present invention without departing from the spirit or scope of the invention.

In addition, the embodiments, features, methods, systems, and details of the invention that are described above in the application may be combined separately or in any combination to create or describe new embodiments of the invention.

What is claimed is:

1. A method, comprising:
dispatching a blog entry to a blog server; and
including the blog entry as a blog entry media item in a media diary,
wherein the blog server employs the dispatched blog entry as a part of a blog, and
wherein the media diary presents, in an automatically organized timeline, the blog entry media item.

2. The method of claim 1, wherein there is coordination between the blog entry media item and the part of the blog.

3. The method of claim 1, wherein the media diary presents, in the automatically organized timeline, further media items.

4. The method of claim 1, wherein the media diary presents a plurality of types of media items.

5. The method of claim 1, further comprising receiving selection of one or more media items from the media diary to include in the blog entry.

6. The method of claim 1, further comprising receiving text to include in the blog entry.

7. The method of claim 1, wherein the media diary presents media items created at the node.

8. The method of claim 1, wherein the media diary presents media items captured at the node.

9. The method of claim 1, wherein the media diary presents media items received at the node.

10. The method of claim 4, wherein the plurality of types includes images.

11. The method of claim 4, wherein the plurality of types includes movies.

12. The method of claim 4, wherein the plurality of types includes sounds.

13. The method of claim 4, wherein the plurality of types includes messages.

14. The method of claim 4, wherein the plurality of types includes blog entries.

15. The method of claim 1, wherein the blog entry media item is updated to include replies to the part of the blog.

16. The method of claim 1, wherein the blog entry media item is updated to include number of accesses of the part of the blog.

17. The method of claim 1, wherein the blog entry media item is updated to include times of accesses of the part of the blog.

18. The method of claim 1, wherein the blog entry media item is updated to include names of users accessing the part of the blog.

19. The method of claim 1, wherein the part of the blog is updated to include changes made to the blog entry media item.

20. The method of claim 1, wherein a blog entry editor is provided.

21. The method of claim 1, further comprising associating metadata with the blog entry.

22. The method of claim 5, further comprising associating, with the selected media items, metadata associated with the blog entry.

23. The method of claim 5, further comprising associating, with the blog entry, metadata associated with the selected media items.

24. The method of claim 5, wherein the selected media items are identified by a user via a blog entry editor.

25. The method of claim 5, wherein the selected media items are placed into a blog folder by a user.

26. The method of claim 1, wherein blog entries of a blog of a user not owning the media diary are stored in the media diary.

27. The method of claim 1, wherein blog entries of a blog of a user not owning the media diary are stored in a blog folder.

28. The method of claim 26, further comprising offering one or more links to the blog.

29. The method of claim 27, further comprising offering one or more links to the blog.

30. The method of claim 1, wherein the blog entry is converted into a format appropriate for a blog.

31. The method of claim 1, wherein one or more templates are provided by a blog service.

32. The method of claim 1, wherein atom is employed.

33. The method of claim 1, wherein really simple syndication is employed.

34. The method of claim 1, further comprising suggesting one or more media items from the media diary for inclusion in the blog entry.

35. The method of claim 34, further comprising comparing blog metadata with metadata associated with one or more media items from the media diary.

36. The method of claim 34, further comprising comparing blog metadata with metadata associated with one or more new media items from the media diary.

37. A method, comprising:
monitoring for changes to a blog; and
providing, to a node, presence data,
wherein the presence data indicates communication availability, and
wherein the presence data indicates change to the blog.

38. The method of claim 37, wherein monitoring for changes to a blog of a user is performed.

39. The method of claim 37, wherein monitoring for changes to a blog of a third party is performed.

40. The method of claim 37, wherein the blog corresponds to a user, and wherein access to the blog is provided via a contacts card corresponding to the user.

41. The method of claim 37, wherein the blog corresponds to a user, and wherein access to the blog is provided via a buddy list entry corresponding to the user.

42. The method of claim 37, wherein the presence data is provided upon a change being made to the blog.

43. The method of claim 37, wherein the presence data is provided periodically.

44. The method of claim 37, wherein the node provides indication in a contacts user interface in the case where a change is made to the blog.

45. The method of claim 37, wherein, while an interface of the node is in an inactive state, the node provides on-screen display in the case where a change is made to the blog.

46. The method of claim 37, wherein atom is employed in monitoring for changes to the blog.

47. The method of claim 37, wherein really simple syndication is employed in monitoring for changes to the blog.

48. The method of claim 37, wherein the blog is accessed in monitoring for changes to the blog

49. The method of claim 37, wherein access to a new entry in the blog is provided.

50. The method of claim 37, wherein the information regarding a new entry in the blog is provided.

51. The method of claim 37, wherein access to a new blog entry reply is provided.

52. The method of claim 37, wherein the information regarding a new blog entry reply is provided.

53. The method of claim 37, wherein the presence data further indicates one or more usage information values for the blog.

54. The method of claim 53, wherein the usage information values comprise one or more numbers of accesses to the blog.

55. The method of claim 53, wherein the usage information values comprise one or more names of users accessing the blog.

56. The method of claim 53, wherein the usage information values comprise one or more times of accesses to the blog.

57. The method of claim 53, wherein the provided presence data is stored in a media diary of the node.

58. The method of claim 53, wherein, while an interface of the node is in an inactive state, the node provides on-screen display regarding one or more usage information values for the blog.

59. A system, comprising:
a memory having program code stored therein; and
a processor disposed in communication with the memory for carrying out instructions in accordance with the stored program code;
wherein the program code, when executed by the processor, causes the processor to perform:
dispatching a blog entry to a blog server; and
including the blog entry as a blog entry media item in a media diary,
wherein the blog server employs the dispatched blog entry as a part of a blog, and
wherein the media diary presents, in an automatically organized timeline, the blog entry media item.

60. The system of claim 59, wherein there is coordination between the blog entry media item and the part of the blog.

61. The system of claim 59, wherein the media diary presents, in the automatically organized timeline, further media items.

62. The system of claim 59, wherein the media diary presents a plurality of types of media items.

63. The system of claim 59, wherein the processor further performs receiving selection of one or more media items from the media diary to include in the blog entry.

64. The system of claim 59, wherein the processor further performs receiving text to include in the blog entry.

65. The system of claim 59, wherein the media diary presents media items created at the node.

66. The system of claim 59, wherein the media diary presents media items captured at the node.

67. The system of claim 59, wherein the media diary presents media items received at the node.

68. The system of claim 62, wherein the plurality of types includes images.

69. The system of claim 62, wherein the plurality of types includes movies.

70. The system of claim 62, wherein the plurality of types includes sounds.

71. The system of claim 62, wherein the plurality of types includes messages.

72. The system of claim 62, wherein the plurality of types includes blog entries.

73. The system of claim 59, wherein the blog entry media item is updated to include replies to the part of the blog.

74. The system of claim 59, wherein the blog entry media item is updated to include number of accesses of the part of the blog.

75. The system of claim 59, wherein the blog entry media item is updated to include times of accesses of the part of the blog.

76. The system of claim 59, wherein the blog entry media item is updated to include names of users accessing the part of the blog.

77. The system of claim 59, wherein the part of the blog is updated to include changes made to the blog entry media item.

78. The system of claim 59, wherein a blog entry editor is provided.

79. The system of claim 59, wherein the processor further performs associating metadata with the blog entry.

80. The system of claim 63, wherein the processor further performs associating, with the selected media items, metadata associated with the blog entry.

81. The system of claim 63, wherein the processor further performs associating, with the blog entry, metadata associated with the selected media items.

82. The system of claim 63, wherein the selected media items are identified by a user via a blog entry editor.

83. The system of claim 63, wherein the selected media items are placed into a blog folder by a user.

84. The system of claim 59, wherein blog entries of a blog of a user not owning the media diary are stored in the media diary.

85. The system of claim 59, wherein blog entries of a blog of a user not owning the media diary are stored in a blog folder.

86. The system of claim 84, wherein the processor further performs offering one or more links to the blog.

87. The system of claim 85, wherein the processor further performs offering one or more links to the blog.

88. The system of claim 59, wherein the blog entry is converted into a format appropriate for a blog.

89. The system of claim 59, wherein one or more templates are provided by a blog service.

90. The system of claim 59, wherein atom is employed.

91. The system of claim 59, wherein really simple syndication is employed.

92. The system of claim 59, wherein the processor further performs suggesting one or more media items from the media diary for inclusion in the blog entry.

93. The system of claim 92, wherein the processor further performs comparing blog metadata with metadata associated with one or more media items from the media diary.

94. The system of claim 92, wherein the processor further performs comparing blog metadata with metadata associated with one or more new media items from the media diary.

95. A system, comprising:
a memory having program code stored therein; and
a processor disposed in communication with the memory for carrying out instructions in accordance with the stored program code;
wherein the program code, when executed by the processor, causes the processor to perform:
monitoring for changes to a blog; and
providing, to a node, presence data,
wherein the presence data indicates communication availability, and
wherein the presence data indicates change to the blog.

96. The system of claim 95, wherein monitoring for changes to a blog of a user is performed.

97. The system of claim 95, wherein monitoring for changes to a blog of a third party is performed.

98. The system of claim 95, wherein the blog corresponds to a user, and wherein access to the blog is provided via a contacts card corresponding to the user.

99. The system of claim 95, wherein the blog corresponds to a user, and wherein access to the blog is provided via a buddy list entry corresponding to the user.

100. The system of claim 95, wherein the presence data is provided upon a change being made to the blog.

101. The system of claim 95, wherein the presence data is provided periodically.

102. The system of claim 95, wherein the node provides indication in a contacts user interface in the case where a change is made to the blog.

103. The system of claim 95, wherein, while an interface of the node is in an inactive state, the node provides on-screen display in the case where a change is made to the blog.

104. The system of claim 95, wherein atom is employed in monitoring for changes to the blog.

105. The system of claim 95, wherein really simple syndication is employed in monitoring for changes to the blog.

106. The system of claim 95, wherein the blog is accessed in monitoring for changes to the blog

107. The system of claim 95, wherein access to a new entry in the blog is provided.

108. The system of claim 95, wherein the information regarding a new entry in the blog is provided.

109. The system of claim 95, wherein access to a new blog entry reply is provided.

110. The system of claim 95, wherein the information regarding a new blog entry reply is provided.

111. The system of claim 95, wherein the presence data further indicates one or more usage information values for the blog.

112. The system of claim 111, wherein the usage information values comprise one or more numbers of accesses to the blog.

113. The system of claim 111, wherein the usage information values comprise one or more names of users accessing the blog.

114. The system of claim 111, wherein the usage information values comprise one or more times of accesses to the blog.

115. The system of claim 111, wherein the provided presence data is stored in a media diary of the node.

116. The system of claim 111, wherein, while an interface of the node is in an inactive state, the node provides on-screen display regarding one or more usage information values for the blog.

117. An article of manufacture comprising a computer readable medium containing program code that when executed causes a node to perform:
dispatching a blog entry to a blog server; and
including the blog entry as a blog entry media item in a media diary,
wherein the blog server employs the dispatched blog entry as a part of a blog, and
wherein the media diary presents, in an automatically organized timeline, the blog entry media item.

118. An article of manufacture comprising a computer readable medium containing program code that when executed causes a server to perform:
monitoring for changes to a blog; and
providing, to a node, presence data,
wherein the presence data indicates communication availability, and
wherein the presence data indicates change to the blog.

119. A node, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
dispatching a blog entry to a blog server; and
including the blog entry as a blog entry media item in a media diary,
wherein the blog server employs the dispatched blog entry as a part of a blog, and
wherein the media diary presents, in an automatically organized timeline, the blog entry media item.

120. A server, comprising:
a memory having program code stored therein;
a processor disposed in communication with the memory for carrying out instructions in accordance with the stored program code; and
a network interface disposed in communication with the processor;
wherein the program code, when executed by the processor, causes the processor to perform:
monitoring for changes to a blog; and
providing, to a node, presence data,
wherein the presence data indicates communication availability, and
wherein the presence data indicates change to the blog.
